(19) United States
(12) Patent Application Publication
(10) Pub. No.: US 2018/0285927 A1
(43) Pub. Date: Oct. 4, 2018

(54) ADVERTISEMENTS IN A MEDIA COLLABORATION SYSTEM

(71) Applicant: Google LLC, Mountain View, CA (US)

(72) Inventors: Johan Georg Granström, Kilchberg (CH); Thomas Weich, Zurich (CH); Steven Dropsho, Zurich (CH)

(21) Appl. No.: 14/727,663

(22) Filed: Jun. 1, 2015

(51) Int. Cl. G06Q 30/02

(52) U.S. Cl. CPC G06Q 30/0251; G06Q 30/0277

(57) ABSTRACT

Systems and techniques for identifying and/or managing advertisements associated with media content are presented. The system can include a media database component and a matching component. The media database component manages a set of advertisement items associated with media content. The matching component compares a media item to the set of advertisement items based on media signature data associated with the media item and the set of advertisement items. The matching component also stores at least a portion of the media item in a database in response to a determination that at least the portion of the media item matches an advertisement item from the set of advertisement items.

### TECHNICAL FIELD

This disclosure relates generally to media content, and more specifically, to identifying and/or managing advertisements associated with media content.

### BACKGROUND

Conventional media content providers allow users to upload media content (e.g., user-generated media content, etc.) to a server (e.g., a media content server). The media content can then be delivered (e.g., streamed) to other users. In certain instances, media content can include an advertisement. Furthermore, it may be desirable to identify an advertisement included in media content. However, it is often difficult to identify and/or manage advertisements associated with media content due to the large variety of media content generally included in and/or uploaded to conventional media content systems.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with an example implementation, a system includes a media database component and a matching component. The media database component manages a set of advertisement items associated with media content. The matching component compares a media item to the set of advertisement items based on media signature data associated with the media item and the set of advertisement items. The matching component also stores at least a portion of the media item in a database in response to a determination that at least the portion of the media item matches an advertisement item from the set of advertisement items.

Additionally, a non-limiting implementation provides for managing a set of advertisement items associated with media content, determining similarity between media signature data associated with a media item and other media signature data associated with the set of advertisement items, and storing at least a portion of the media item in a database in response to a determination that at least the portion of the media item corresponds to an advertisement item from the set of advertisement items.

In accordance with another example implementation, a non-transitory computer readable storage medium comprising computer-executable instructions, that in response to execution, cause a computing system to perform operations, comprising: managing a set of advertisement items associated with media content, comparing media signature data associated with a media item to other media signature data associated with the set of advertisement items, and storing an advertisement item associated with at least a portion of the media item in a database in response to a determination that at least the portion of the media item corresponds to another advertisement item included in the set of advertisement items.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example media classification component, in accordance with various aspects and implementations described herein;

FIG. 2 illustrates a high-level block diagram of another example media classification component, in accordance with various aspects and implementations described herein;

FIG. 3 illustrates a high-level block diagram of yet another example media classification component, in accordance with various aspects and implementations described herein;

FIG. 4 illustrates a high-level block diagram of a media classification component in connection with an interface component, in accordance with various aspects and implementations described herein;

FIG. 5 illustrates an example system for managing advertisements associated with media content, in accordance with various aspects and implementations described herein;

FIG. 6 illustrates an example user interface, in accordance with various aspects and implementations described herein;

FIG. 7 depicts a flow diagram of an example method for managing media content associated with advertisements, in accordance with various aspects and implementations described herein;

FIG. 8 depicts a flow diagram of an example method for managing a service for media content associated with an advertisement, in accordance with various aspects and implementations described herein;

FIG. 9 depicts a flow diagram of an example method for modifying media content associated with an advertisement, in accordance with various aspects and implementations described herein;

FIG. 10 depicts a flow diagram of an example method for managing an advertisement database, in accordance with various aspects and implementations described herein;

FIG. 11 is a schematic block diagram illustrating a suitable operating environment; and

FIG. 12 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Conventional media content providers allow users to upload media content (e.g., user-generated media content, etc.) to a server (e.g., a media content server). The media content can then be delivered (e.g., streamed) to other users. In certain instances, media content can include an advertisement. Furthermore, it may be desirable to identify an advertisement included in media content. However, it is often difficult to identify and/or manage advertisements associated with media content due to the large variety of media content generally included in and/or uploaded to conventional media content systems.

To these and/or related ends, techniques for identifying and/or managing advertisements associated with media content are presented. For example, techniques for collecting advertisements associated with media content, matching uploaded media content against advertisements associated with media content, managing a service for media content associated with an advertisement and/or modifying media content associated with an advertisement (e.g., excluding one or more advertisements from media content to generate a modified version of media content) can be provided. A set of media content that is previously determined to be associated with advertisements (e.g., media content that is known to be an advertisement) can be employed to identify and/or manage advertisement content uploaded to a media collaboration system. In an aspect, media signature data (e.g., media fingerprint data, an index of advertisements, etc.) can be employed to facilitate improved identification and/or management of advertisements associated with media content. In another aspect, an index of advertisements can be generated and/or managed to facilitate improved identification and/or management of advertisements associated with media content.

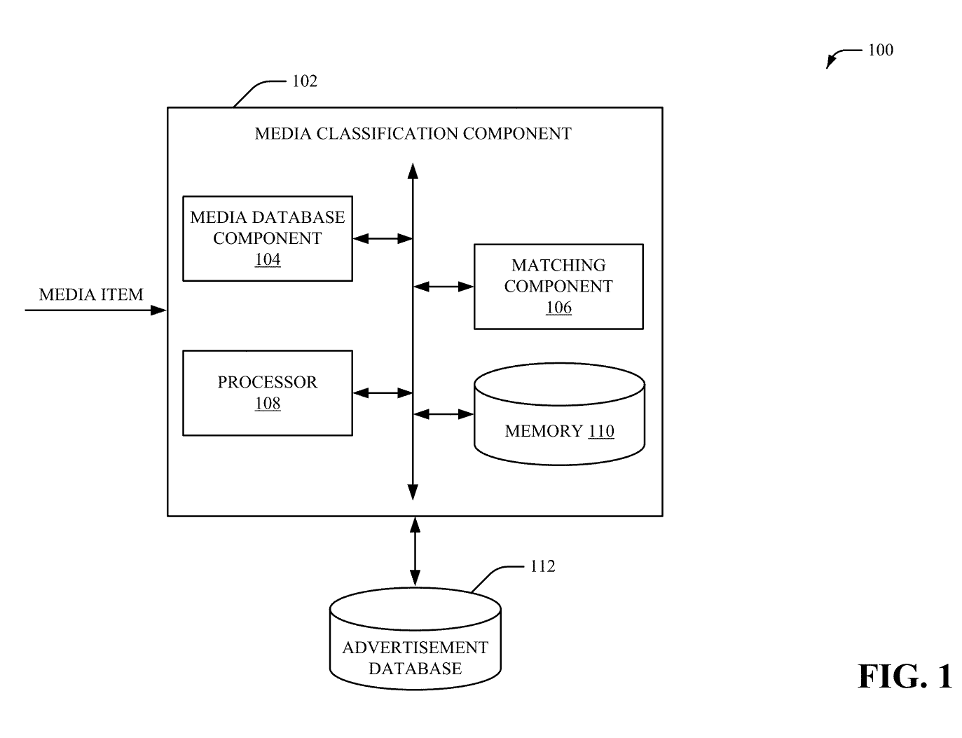

Referring initially to FIG. 1, there is illustrated an example system 100 that identifies and/or manages advertisements associated with media content, according to an aspect of the subject disclosure. In one example, the system 100 can be implemented on or in connection with at least one server (e.g., at least one server that hosts and/or modifies user-uploaded media content). The system 100 can be employed by various systems, such as, but not limited to media collaboration systems, content identification systems, media content systems, media sharing systems, media editing systems, media recommendation systems, advertisement systems, media advertisement systems, content management systems, network systems, computer network systems, communication systems, router systems, server systems, high availability server systems (e.g., Telecom server systems), Web server systems, file server systems, media server systems, media content server systems, disk array systems, powered insertion board systems, cloud-based systems, and the like.

Specifically, the system 100 can provide a media classification feature with a media database feature (e.g., media database component 104) and a matching feature (e.g., matching component 106) that can be utilized in and/or in connection with, for example, a media application (e.g., a media collaboration application, a media sharing application, a media advertisement application, etc.). The media database feature can manage a set of advertisement items associated with media content. The matching feature can compare a media item to the set of advertisement items based on media signature data associated with the media item and the set of advertisement items. The matching feature can also store at least a portion of the media item in a database in response to a determination that at least the portion of the media item matches an advertisement item from the set of advertisement items.

In particular, the system 100 can include a media classification component 102. In FIG. 1, the media classification component 102 includes a media database component 104 and a matching component 106. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. System 100 can include memory 110 for storing computer executable components and instructions. System 100 can further include a processor 108 to facilitate operation of the instructions (e.g., computer executable components and instructions) by system 100.

The media classification component 102 (e.g., the media database component 104) can receive a media item (e.g., MEDIA ITEM shown in FIG. 1). In one example, the media item can be associated with and/or stored on at least one server (e.g., a remote server, a media content server, etc.) prior to being received by the media classification component 102 (e.g., the media database component 104). In another example, a user device can transmit (e.g., directly transmit or indirectly transmit) the media item to the media classification component 102 (e.g., the media database component 104). The media item can be, for example, an uploaded media item (e.g., a media item uploaded to a media sharing platform, a media item uploaded to at least one server, etc.). A user device can include a computer, a laptop computer, a mobile device, a handheld device, a cellular phone (e.g., a smartphone), a tablet, an interactive television, an internet-connected television, a set-top box, a streaming media device, a wearable computing device, a camera, a personal digital assistant (PDA), an electronic reader (e-reader), a portable computing device, a gaming device, another type of media capable device, etc. The media item can include one or more types of media content. For example, the media item can include video (e.g., a video file, a video clip, a video segment, a video sample, etc.) and/or audio (e.g., an audio file, an audio clip, an audio sample, a music file, a music clip, a music sample, a song, a sound, a dialogue, etc.). It is to be appreciated that the media item can be in any recognizable media file format (e.g., video file format and/or audio file format), codec compression format, etc. In an aspect, the media item can be associated with an advertisement (e.g., at least a portion of the media item can be an advertisement). The advertisement can include one or more types of media content. For example, the advertisement can include video content and/or audio content. In one example, an advertisement item can be embedded in the media item. The advertisement item can be, in one example, a content item that meets certain criteria with respect to an advertisement.

The media database component 104 can manage a set of advertisement items associated with media content. For example, a set of advertisement items can be stored in the advertisement database 112. Each advertisement item in the set of advertisement items can include one or more types of media content. For example, each advertisement item in the set of advertisement items can include video content and/or audio content. Additionally or alternatively, each advertisement item in the set of advertisement items can be associated with an index (e.g., an identifier). The media database component 104 in connection with the advertisement database 112 can facilitate a system for collecting, identifying and/or managing advertisements. In one example, an advertisement item included in the set of advertisement items can be an online advertisement. The advertisement database 112 can be associated with a library of identified advertisement items (e.g., previously identified advertisement items, previously determined advertisement items, etc.). Each advertisement item can be identified as an advertisement by the media classification component 102 and/or a user identity that provided (e.g., generated and/or uploaded) the advertisement item. Therefore, the library can be implemented as a cross-reference to identify an advertisement item. In one example, the advertisement database 112 can be associated with a server in communication with the media database component 104.

In an aspect, the media database component 104 can add an advertisement item to the set of advertisement items stored in the advertisement database 112. For example, the media database component 104 can store a particular media item (e.g., media content) in the advertisement database 112 in response to an activation process associated with the media content (e.g., when the particular media item is activated as an advertisement). Additionally or alternatively, the media database component 104 can add information associated with an advertisement item (e.g., an index for the advertisement item, an identifier for the advertisement item, metadata for the advertisement item, etc.) in response to an activation process associated with the media content (e.g., when the particular media item is activated as an advertisement). In another aspect, the media database component 104 can remove an advertisement item from the set of advertisement items in response to a defined criterion. For example, the media database component 104 can remove an advertisement item from the set of advertisement items after a defined period of time (e.g., one week, one month, 90 days, one year, etc.). In another example, the media database component 104 can remove an advertisement item from the set of advertisement items in response to an action (e.g., a request by a user identity associated with the advertisement item to remove the advertisement item, etc.).

The matching component 106 can identify one or more advertisement items in the media item. The matching component 106 can compare the media item to the set of advertisement items based on media signature data associated with the media item and the set of advertisement items. For example, the matching component 106 can compare the media item to the set of advertisement items based on media signature data associated with the media item and other media signature data associated with the set of advertisement items. Therefore, the matching component 106 can determine whether the portion of the media item matches (e.g., corresponds to) the advertisement item from the set of advertisement items based on the comparison of the media signature data associated with the media item and the set of advertisement items. Additionally, the matching component 106 can store at least a portion of the media item in the advertisement database 112 in response to a determination that at least the portion of the media item matches an advertisement item from the set of advertisement items. The matching component 106 can store, for example, a portion of the media item associated with an advertisement in the advertisement database 112 in response to a determination that the portion of the media item is an advertisement. The matching component 106 can additionally associate the media item with an event in response to the determination that the media item matches the advertisement item from the set of advertisement items. For example, the matching component 106 can associate the media item with an identifier for the media item, the matching component 106 can associated the media item with an identifier for an advertisement, the matching component 106 can initiate a process, the matching component 106 can store timestamp information associated with the media item and/or an advertisement, the matching component 106 can store other information associated with the media item and/or an advertisement, etc. In an implementation, the matching component 106 can compare an uploaded media item that is received from a user device to the set of advertisement items based on the media signature data and/or can store at least a portion of the uploaded media item in the advertisement database 112 in response to a determination that at least the portion of the uploaded media item matches an advertisement item from the set of advertisement items.

Media signature data can be associated with spectrogram data and/or content fingerprint data. For example, the media signature data can be associated with, audio spectrogram data, video spectrogram data, audio fingerprint data and/or video fingerprint data. In certain implementations, media signature data can be associated with a set of min-hash signatures for audio data and/or video data. An audio spectrogram can be generated based on audio channel data of media content (e.g., the media item and/or an advertisement item). For example, an audio spectrogram can represent audio channel data by plotting time on one axis and frequency on another axis. Similarly, a video spectrogram can be generated based on video channel data of media (e.g., the media item and/or an advertisement item). Video spectrogram can represent, for example, video channel data by plotting time on one axis and frequency on another axis. Amplitude or intensity of a certain frequency at a certain time can also be incorporated into an audio spectrogram by using color and/or additional dimensions. As such, an audio spectrogram can be generated by combining respective measurements over time on a frequency axis to generate a spectrogram image of frequency amplitudes over time. In certain implementations, a spectrogram can be generated based at least in part on a short-time Fourier transform (“STFT”). For example, audio channel data and/or video channel data of media content (e.g., the media item and/or an advertisement item) can be partitioned into one or more time windows. Accordingly, each of the one or more time windows (e.g., the audio channel data and/or the video channel data) can be processed based at least in part on a STFT. Each of the one or more time windows can be Fourier transformed to calculate a magnitude of the frequency spectrum for the duration of each window. As such, an image of frequency amplitudes over time can be generated by combining a plurality of windows side by side on the time axis of a spectrogram. It is to be appreciated that other techniques, such as wavelet transforms, can also be used to construct a spectrogram.

In certain implementations, media signature data can be associated with a plurality of content fingerprints (e.g., a set of audio fingerprints and/or a set of video fingerprints). A set of audio fingerprints and/or a set of video fingerprints can be generated based at least in part on a hash technique (e.g., fingerprints in the set of audio fingerprints and/or the set of video fingerprints can be min-hashes). For example, a set of audio fingerprints can be generated based at least in part on a hash of a spectrogram window (e.g., a min-hash technique) of an audio spectrogram. Additionally or alternatively, a set of video fingerprints can be generated based in part on a hash of a window (e.g., a min-hash technique) associated with the video channel data. In one example, a locality sensitive hashing (LSH) scheme can be employed to generate a set of audio fingerprints and/or a set of video fingerprints. An LSH scheme can implement, in one example, a random hashing scheme. In an example, a min-hash (e.g., weighted min-hash, a min-wise independent permutation, etc.) can be implemented. As such, a set of audio fingerprints and/or a set of video fingerprints can be generated based on a hashing scheme. It is to be appreciated that other types of hashing schemes can be employed to generate a set of audio fingerprints and/or a set of video fingerprints. In one example, a combination of computer vision techniques and/or data stream processing algorithms can be implemented to generate a set of audio fingerprints and/or a set of video fingerprints. A set of audio fingerprints and/or a set of video fingerprints can be alternatively be generated based at least in part on wavelets (e.g., one or more wavelet vectors). In certain implementations, each content fingerprint (e.g., each audio fingerprint and/or each video fingerprint) can comprise a sequence of sub-fingerprints. A sub-fingerprint can be a data element that encodes data related to image features and/or audio features of a media content (e.g., the media item and/or an advertisement item). A sub-fingerprint can represent media content (e.g., a video) at a particular time (e.g., a sub-fingerprint can include data associated with a particular time range for a video, etc.). In an implementation, a sub-fingerprint can comprise min-hash values based on the image features and/or audio features (e.g., a sub-fingerprint can comprise a vector of min-hash values, a sub-fingerprint can comprise a band of min-hash values, a sub-fingerprint can comprise a locality-sensitive hashing band of min-hash values, etc.). Therefore, the matching component 106 can employ one or more media fingerprint techniques and/or one or more hashing schemes to identify an advertisement item associated with media content.

To facilitate identifying one or more advertisement items in the media item, the matching component 106 can also compute similarity between the media signature data (e.g., media fingerprint data) associated with the media item and other media signature data (e.g., other media fingerprint data) associated with the set of advertisement items. The matching component 106 can compute the similarity, in one example, based on hashing scheme values (e.g., min-hash data values) of the media signature data associated with the media item and corresponding hashing scheme values (e.g., corresponding min-hash data values) of the other media signature data associated with the set of advertisement items. In an aspect, the matching component 106 can determine whether the portion of the media item matches the advertisement item from the set of advertisement items based on a distance metric. In one example, the matching component 106 can compute similarity between media signature data associated with the media item and other media signature data associated with the set of advertisement items based on a Hamming distance. In another example, the matching component 106 can compute similarity between media signature data associated with the media item and other media signature data associated with the set of advertisement items based on a Jaccard distance. However, other mechanisms for computing similarity between media signature data associated with the media item and other media signature data associated with the set of advertisement items can be employed.

In a non-limiting example where a user video is uploaded and/or received by the media classification component 102, the user video can be matched against a set of advertisements to determine if the uploaded user video (e.g., at least a portion of the uploaded user video) matches an advertisement (e.g., at least a portion of an advertisement). If a match is found, the uploaded user video and/or information associated with the uploaded user video can be stored in a database (e.g., the advertisement database 112) and/or can be published as an event. In one example, the uploaded user video can be a reference video scheduled for activation by a user identity.

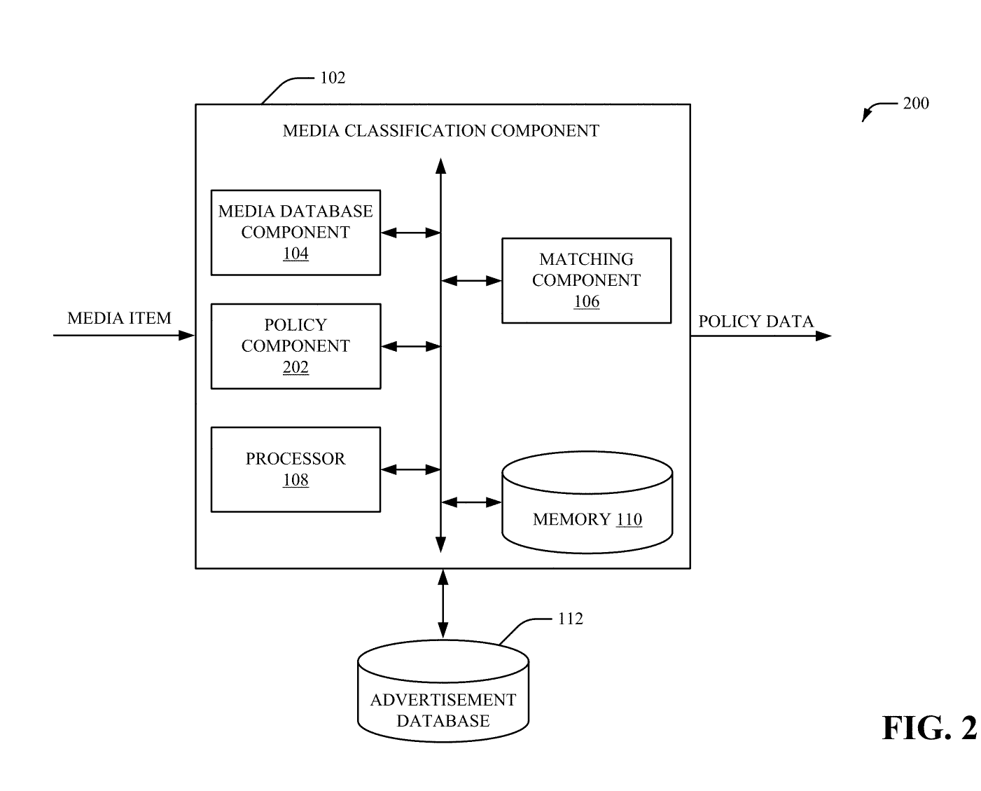

Referring now to FIG. 2, there is illustrated a non-limiting implementation of a system 200 in accordance with various aspects and implementations of this disclosure. The system 200 includes the media classification component 102. The media classification component 102 includes the media database component 104, the matching component 106 and a policy component 202.

The policy component 202 can manage a service associated with media content (e.g., a media item received by the media classification component 102, an uploaded media item received by the media classification component 102, etc.). The policy component 202 can also receive and/or process a request for a service associated with media content (e.g., a media item, an uploaded media item). In a non-limiting example, a request for a service can be a request to monetize media content. The request for the service can be associated with a user identity. In an implementation, the policy component 202 can receive user input associated with a request for a service related to media content. Furthermore, the policy component 202 can send a request for a service to the matching component 106 based on the user input. In certain implementations, the policy component 202 can be implemented in connection with a user interface on a user device and/or a cloud-based application. Furthermore, the policy component 202 can generate policy data (e.g., POLICY DATA shown in FIG. 2) related to a policy for the media item. In one example, the policy data can be related to a grant or refusal for a service associated with the media item.

In an aspect, the matching component 106 can compare media content (e.g., the media item, the uploaded media item, etc.) to the set of advertisement items in response to a request for a service associated with the media content. The policy component 202 can grant the service to a user identity associated with the media content media content (e.g., the media item, the uploaded media item, etc.) in response to a determination that the media content does not match an advertisement item from the set of advertisement items (e.g., an advertisement item stored in the advertisement database 112). Alternatively, the policy component 202 can withhold from granting the service to a user identity associated with the media content media content (e.g., the media item, the uploaded media item, etc.) in response to a determination that the media content matches an advertisement item from the set of advertisement items (e.g., an advertisement item stored in the advertisement database 112). Therefore, in an non-limiting example, media content (e.g., a video) can be looked up against a set of advertisements (e.g., a set of advertisements stored in the advertisement database 112) when a user requests that the media content (e.g., the video) be monetized and/or claims ownership of the media content. If a match is found, monetization of the media content can be rejected, but appealable. If a match is not found, monetization of the media content can be granted.

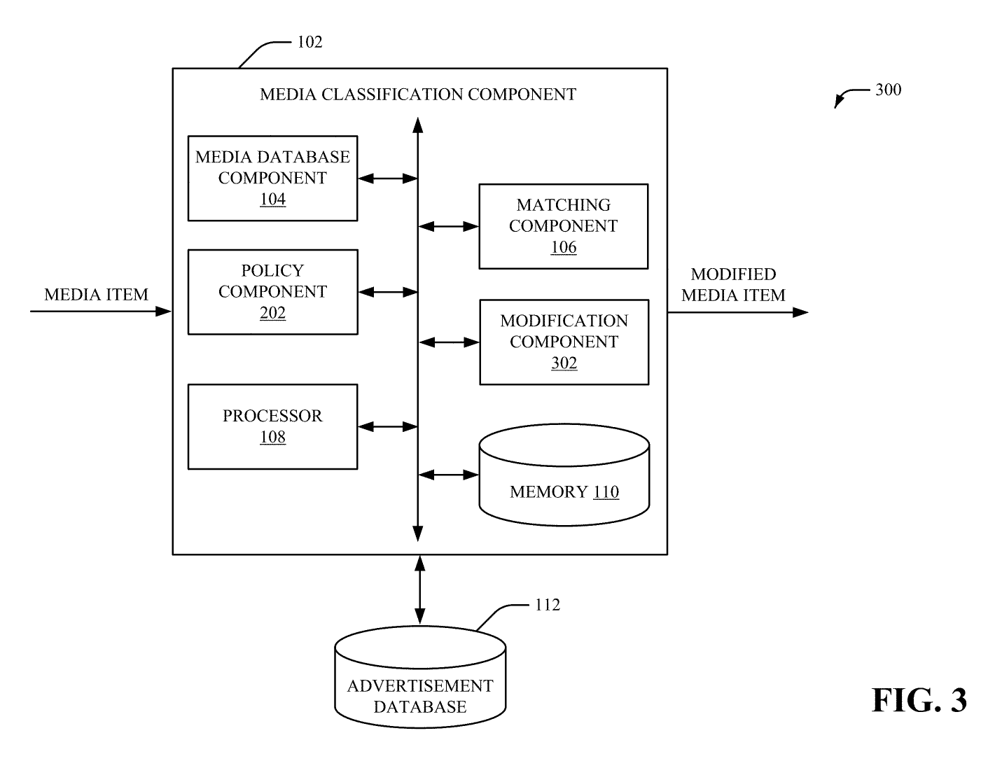

Referring now to FIG. 3, there is illustrated a non-limiting implementation of a system 300 in accordance with various aspects and implementations of this disclosure. The system 300 includes the media classification component 102. The media classification component 102 includes the media database component 104, the matching component 106, the policy component 202 and/or a modification component 302. The modification component 302 can generate a modified media item (e.g., MODIFIED MEDIA ITEM shown in FIG. 3). The modified media item can be a modified version of the media item. For example, the modified media item can be a version of the media item without one or more advertisement items.

In a non-limiting example where the media item is a reference media item selected by a user, the matching component 106 can compare the media item (e.g., the reference media item) to the set of advertisement items based on media signature data. For example, a reference media item can be a televised sporting event that includes one or more advertisements (e.g., one or more commercials). The modification component 302 can generate a modified version of the media item in response to a determination that at least a portion of the media item (e.g., the reference media item) matches an advertisement item from the set of advertisement items. The modification component 302 can remove, for example, a particular advertisement item from the media item (e.g., the reference media item) that matches the advertisement item (e.g., the advertisement item from the set of advertisement items) to generate a modified version of the media item. In an example where the reference media item is a televised sporting event that includes one or more advertisements (e.g., one or more commercials), the modification component 302 can remove the one or more advertisements from the reference media items so that a modified version of the reference media item only includes media content associated with the televised sporting event. Additionally, the policy component 202 can withhold from activating a service for the media item (e.g., the reference media item) in response to a determination that at least a portion of the media item (e.g., the reference media item) matches an advertisement item from the set of advertisement items. In an aspect, the modification component 302 can upload the modified media item to and/or store the modified media item on a remote server (e.g., a media content server). Additionally or alternatively, the modification component 302 can transmit the modified media item for display on a user device.

By employing the modification component 302, when a match is found, one or more segments of a media item (e.g., a reference media item) that matches an advertisement can be excluded from activation of the media item. Thus, an advertisement portion of the media item (e.g., the reference media item) can be prohibited from participation in a claim. In an aspect, certain user identities can be exempt from participation in a claim. For example, advertisement portions of reference media items for user identities established as a partner can be automatically disabled for claiming. Accordingly, if a user identity established as an owner of an advertisement does not ingest the advertisement as a reference media item, media content associated with the advertisement can be freely copied by users as long as the users do not attempt to monetize the media content containing the advertisement. Moreover, users that upload media content with advertisements will not have the media content claimed because of an advertisement. If an owner of the advertisement does ingest the media content as a reference media item, a selected policy for the owner will be applied to media content (e.g., videos) that contain the advertisement of the owner, but other content owners will be stopped from making interfering claims.

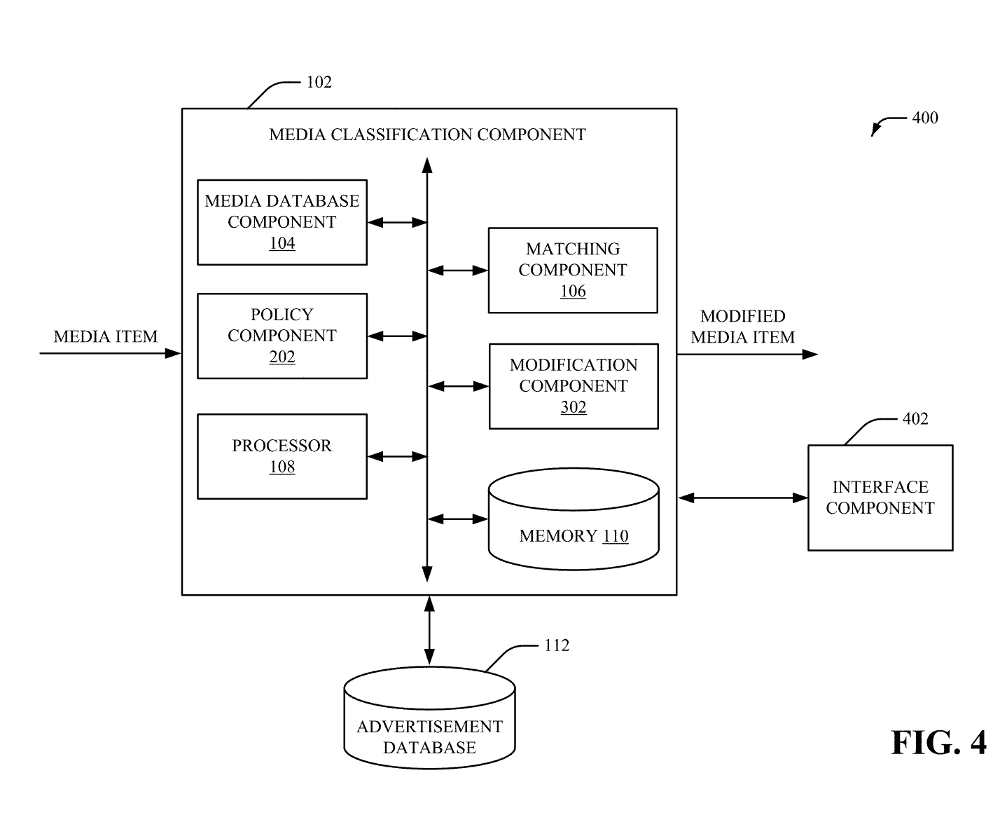

Referring now to FIG. 4, there is illustrated a non-limiting implementation of a system 400 in accordance with various aspects and implementations of this disclosure. The system 400 can include the media classification component 102 and an interface component 402. The media classification component 102 includes the media database component 104, the matching component 106, the policy component 202 and/or the modification component 302. In an implementation, the interface component 402 can be implemented separate from the media classification component 102. In another implementation, the media classification component 102 can include the interface component 402.

The interface component 402 can generate a user interface (e.g., a display) to present information associated with the media classification component 102. For example, the interface component 402 can generate a user interface (e.g., a display) to present policy data, a modified media item, an advertisement item, information (e.g., textual information, metadata, etc.) associated with a modified media item, information (e.g., textual information, metadata, etc.) associated with an advertisement item and/or other information associated with the media classification component 102. The system 400 (e.g., the interface component 402) can be integrated with a cloud-based application. In one example, a request for a service associated with media content can initiated by a user (e.g., a user identity) via the interface component 402.

While FIGS. 1-4 depict separate components in system 100, 200, 300 and 400, it is to be appreciated that two or more components may be implemented in a common component. Further, it can be appreciated that the design of system 100, 200, 300 and 400 can include other component selections, component placements, etc., to facilitate identifying and/or managing advertisements associated with media content.

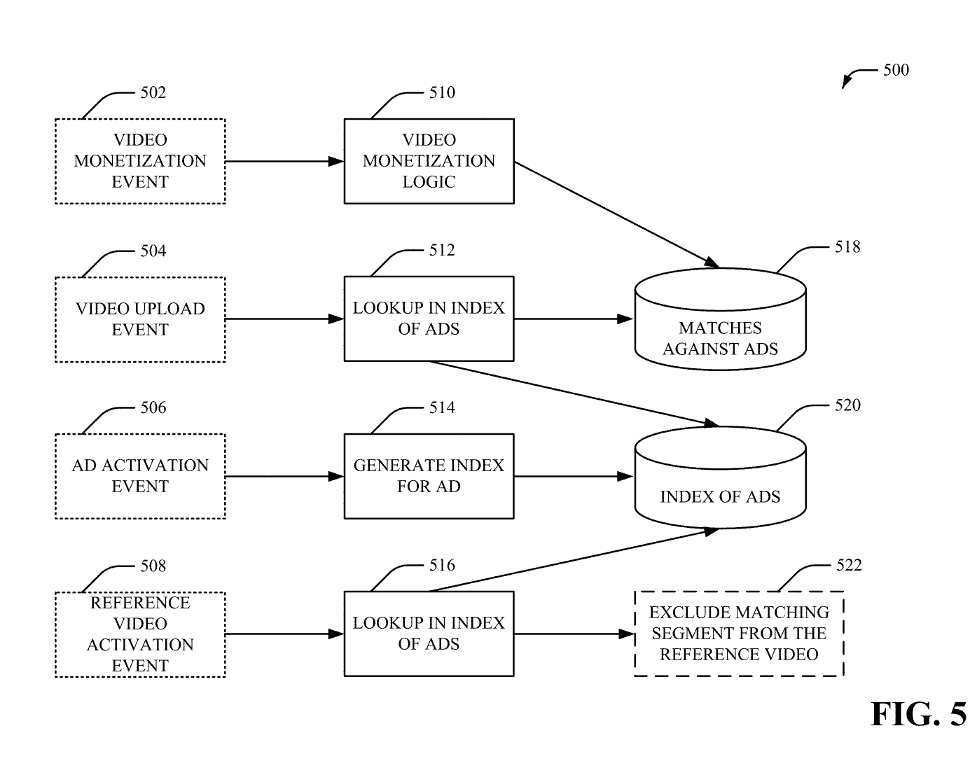

Referring to FIG. 5, there is illustrated a non-limiting implementation of a system 500 in accordance with various aspects and implementations of this disclosure. System 500 includes an event 502, an event 504, an event 506 and an event 508. For example, the event 502 can be a video monetization event, the event 504 can be a video upload event, the event 506 can be associated with an advertisement (e.g., ad) activation event, and the event 508 can be associated with a reference video activation event. The event 502, the event 504, the event 506 and/or the event 508 can be associated with the media classification component 102. Additionally, step 510, step 512, step 514, step 516 and/or step 522 can be associated with the media classification component 102.

At the event 502, a request to monetize a video can be received. At 510, video monetization logic can be employed to determine whether to grant monetization to the video. Monetization of the video can be granted, for example, in response to a determination that the video does not match an advertisement (e.g., an advertisement item) stored in a database 518. At the event 504, a video can be uploaded (e.g., by a user). At 512, the uploaded video can be compared to an index of advertisements (e.g., an index of advertisements stored in a database 520). If the uploaded video matches an advertisement associated with the index of advertisements, the uploaded video can be added to the database 518. At the event 506, an advertisement activation process can occur. For example, a user identity can provide a video associated with an advertisement. At 514, an index for the advertisement can be generated. Furthermore, the index for the advertisement can be stored in the database 520. At the event 508, a reference video activation event can occur. A reference video can be uploaded, for example, by a user identity. At 516, the reference video can be compared to an index of advertisements (e.g., an index of advertisements stored in the database 520). If the reference video matches an advertisement associated with the index of advertisements, at 522 a matching segment from the reference video can be excluded (e.g., a segment of the reference video that matches an advertisement associated with the index of advertisements can be removed from the reference video).

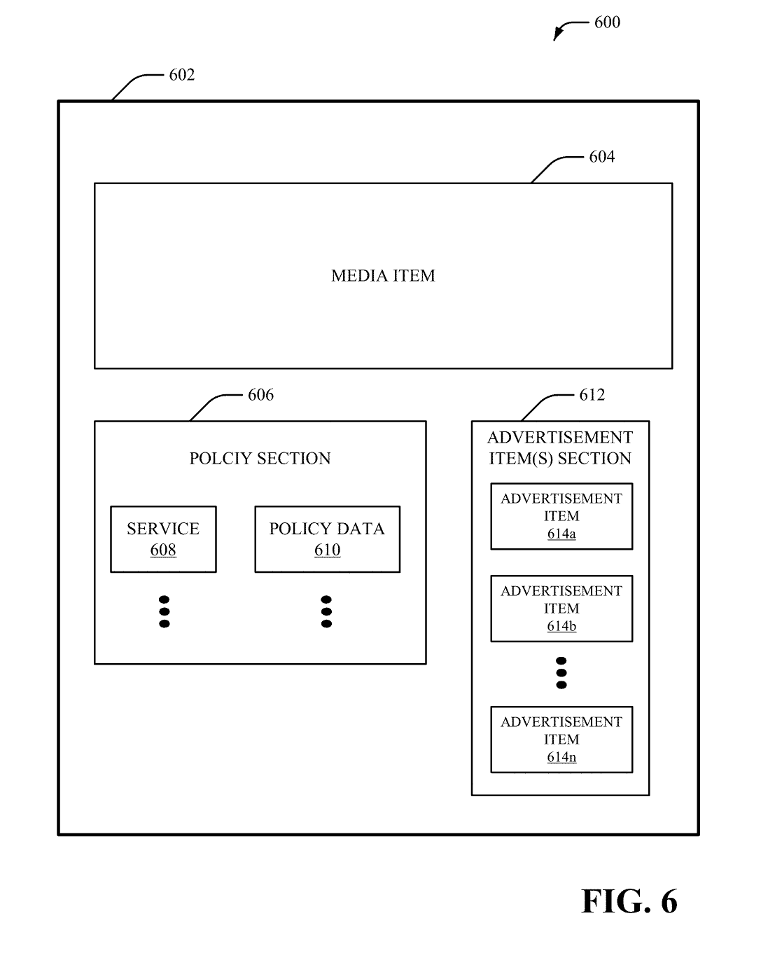

Referring to FIG. 6, there is illustrated a non-limiting implementation of a system 600, in accordance with various aspects and implementations of this disclosure. In an aspect, the system 600 can be associated with the interface component 402. The system 600 illustrates an example webpage 602 (e.g., a user interface to allow a user to manage advertisement(s) associated with a media item 604). The webpage 602 can be presented on a display of a user device (e.g., a user device associated with a user identity that generated and/or uploaded the media item 604). The user device can include a computer, a laptop computer, a mobile device, a handheld device, a cellular phone (e.g., a smartphone), a tablet, an interactive television, an internet-connected television, a set-top box, a streaming media device, a wearable computing device, a camera, a personal digital assistant (PDA), an electronic reader (e-reader), a portable computing device, a gaming device, another type of media capable device, etc. In one example, the media item 604 can be a video and the webpage 602 can be a video hosting website (e.g., a video collaboration website, etc.). The media item 604 can be associated with, for example, a media file received by the media classification component 102.

The webpage 602 can include the media item 604, a policy section 606 and an advertisement item(s) section 612. The policy section 606 can include information associated with a service 608 and/or information associated with policy data 610. As such, a user can view information associated with a policy for the media item 604. The policy data 610 can be, for example, a policy determined by the policy component 202. The advertisement item(s) section 612 can present the user with one or more advertisement items 614a-n associated with the media item 604 and/or information related to one or more advertisement items 614a-n associated with the media item 604. For example, the one or more advertisement items 614a-n included in the replacement item section(s) 612 can be associated with information (e.g., textual information, metadata, etc.) and/or media output associated with the one or more advertisement items 614a-n. It is to be appreciated that the webpage 602 is merely an example. Therefore, the location and/or content of the media item 604, the policy section 606 and/or the advertisement item(s) section 612 can be varied. Furthermore, the webpage 602 can include other features, content and/or functionalities not shown in FIG. 6.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

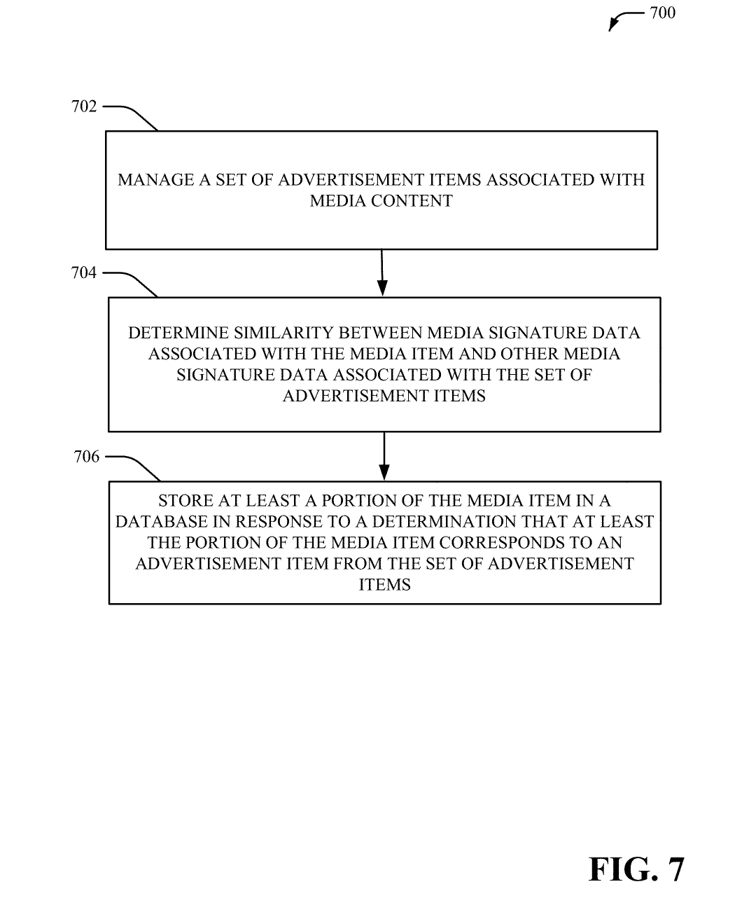

FIGS. 7-10 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 7, there illustrated is a methodology 700 for managing media content associated with advertisements, according to an aspect of the subject innovation. As an example, methodology 700 can be utilized in various applications, such as, but not limited to, media collaboration systems, content identification systems, media content systems, media sharing systems, media editing systems, media recommendation systems, advertisement systems, media advertisement systems, content management systems, network systems, computer network systems, communication systems, router systems, server systems, high availability server systems (e.g., Telecom server systems), Web server systems, file server systems, media server systems, media content server systems, disk array systems, powered insertion board systems, cloud-based systems, etc. At 702, a set of advertisement items associated with media content is managed (e.g., by a media database component 104). For example, a set of advertisement items stored in a database can be managed. The set of advertisement items can be associated with media content. Additionally or alternatively, the set of advertisement items can be associated with an index of advertisements.

At 704, similarity between media signature data associated with the media item and other media signature data associated with the set of advertisement items is determined (e.g., by a matching component 106). For example, media signature data associated with the media item can be compared to other media signature data associated with the set of advertisement items to facilitate determining whether the portion of the media item is associated with an advertisement item. In an aspect, similarity between media fingerprint data associated with the media item and other media fingerprint data associated with the set of advertisement items can be determined.

At 706, at least a portion of the media item is stored in a database (e.g., by a matching component 106) in response to a determination that at least the portion of the media item corresponds to an advertisement item from the set of advertisement items. For example, at least a portion of the media item and/or information associated with the portion of the media item (e.g., an index, metadata, etc.) can be stored in a database in response to a determination that the portion of the media item is associated with an advertisement item.

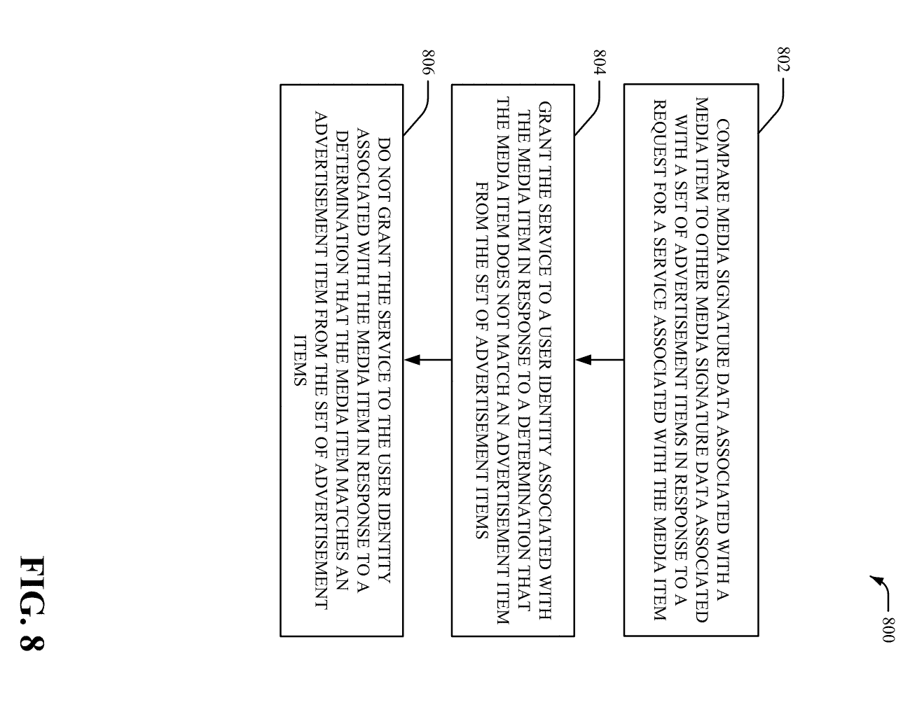

Referring to FIG. 8, there illustrated is an example methodology 800 for managing a service for media content associated with an advertisement, according to an aspect of the subject innovation. At 802, media signature data associated with a media item is compared to other media signature data associated with a set of advertisement items (e.g., by a matching component 106) in response to a request for a service associated with the media item. In a non-limiting example, the request can be a request to monetize and/or claim ownership to the media item.

At 804, the service is granted to a user identity associated with the media item (e.g., by a policy component 202) in response to a determination that the media item does not match an advertisement item from the set of advertisement items. For example, the request to monetize and/or claim ownership to the media item can be allowed in response to a determination that the media item is not associated with a previously determined advertisement item stored in a database.

At 806, the service is not granted to the user identity associated with the media item (e.g., by a policy component 202) in response to a determination that the media item matches an advertisement item from the set of advertisement items. For example, the request to monetize and/or claim ownership to the media item can be denied in response to a determination that the media item is associated with a previously determined advertisement item stored in a database.

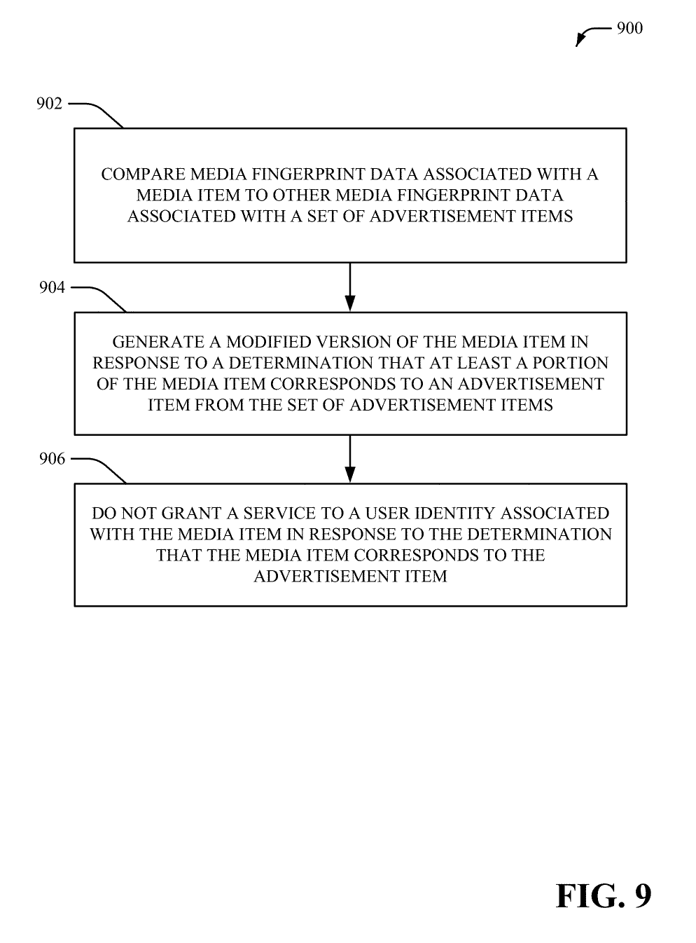

Referring to FIG. 9, there illustrated is an example methodology 900 for modifying media content associated with an advertisement, according to an aspect of the subject innovation. At 902, media fingerprint data associated with a media item is compared to other media fingerprint data associated with a set of advertisement items (e.g., by a matching component 106). Media fingerprint data can include, for example, feature detection data, spectrogram data, audio fingerprint data, video fingerprint data, hashing scheme data, min-hash values and/or other media signature data. In an aspect, the media item can be a reference media item.

At 904, a modified version of the media item is generated (e.g., by a modification component 302) in response to a determination that at least a portion of the media item corresponds to an advertisement item from the set of advertisement items. For example, one or more advertisement items can be removed from the media item to generate a modified media item.

At 906, a service is not granted to a user identity associated with the media item (e.g., by a policy component 202) in response to the determination that the media item corresponds to the advertisement item. For example, monetization and/or claim ownership of the media item can be denied in response to the determination that the media item corresponds to the advertisement item.

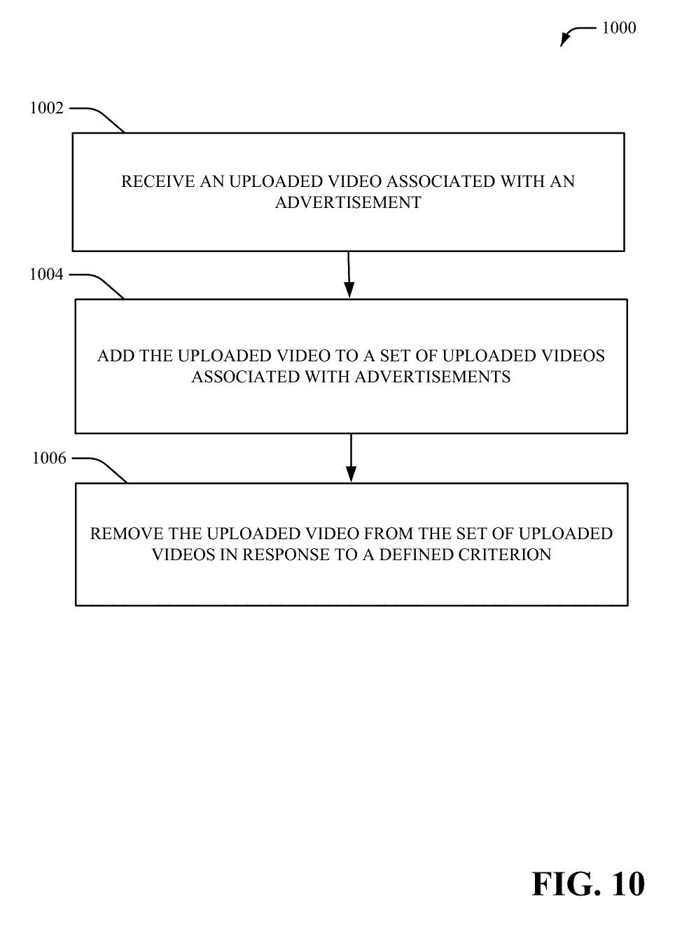

Referring to FIG. 10, there illustrated is an example methodology 1000 for managing an advertisement database, according to an aspect of the subject innovation. At 1002, an uploaded video associated with an advertisement is received (e.g., by a media database component 104). For example, the uploaded video associated with the advertisement can be received during an activation process. In an aspect, one or more portions of the uploaded video that includes an advertisement can be identified.

At 1004, the uploaded video is added to a set of uploaded videos associated with advertisements (e.g., by a media database component 104). For example, the uploaded video, one or more portions of the uploaded video that includes an advertisement, information associated with the uploaded video and/or information associated with the one or more portions of the uploaded video that includes an advertisement can be stored in an advertisement database.

At 1006, the uploaded video is removed from the set of uploaded videos (e.g., by a media database component 104) in response to a defined criterion. For example, the uploaded video, one or more portions of the uploaded video that includes an advertisement, information associated with the uploaded video and/or information associated with the one or more portions of the uploaded video that includes an advertisement can be removed from the advertisement database. In an aspect, the uploaded video can be removed from the set of uploaded videos after a defined period of time (e.g., one week, one month, 90 days, one year, etc.). In another aspect, the uploaded video can be removed from the set of uploaded videos in response to an action to remove the uploaded video (e.g., a request by a user identity associated with the uploaded video to remove the uploaded video, etc.).

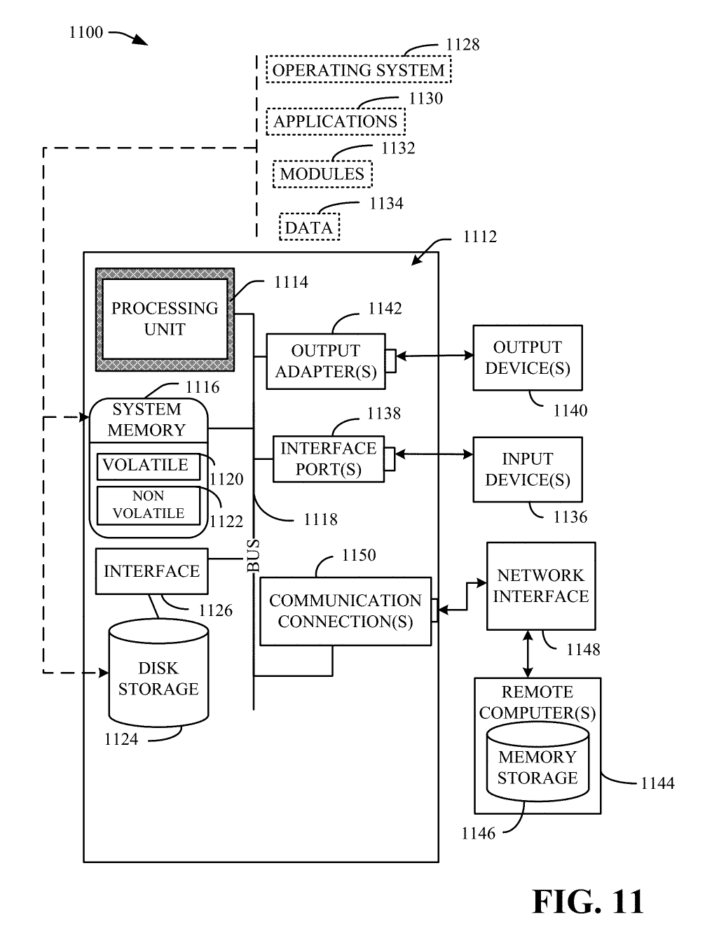

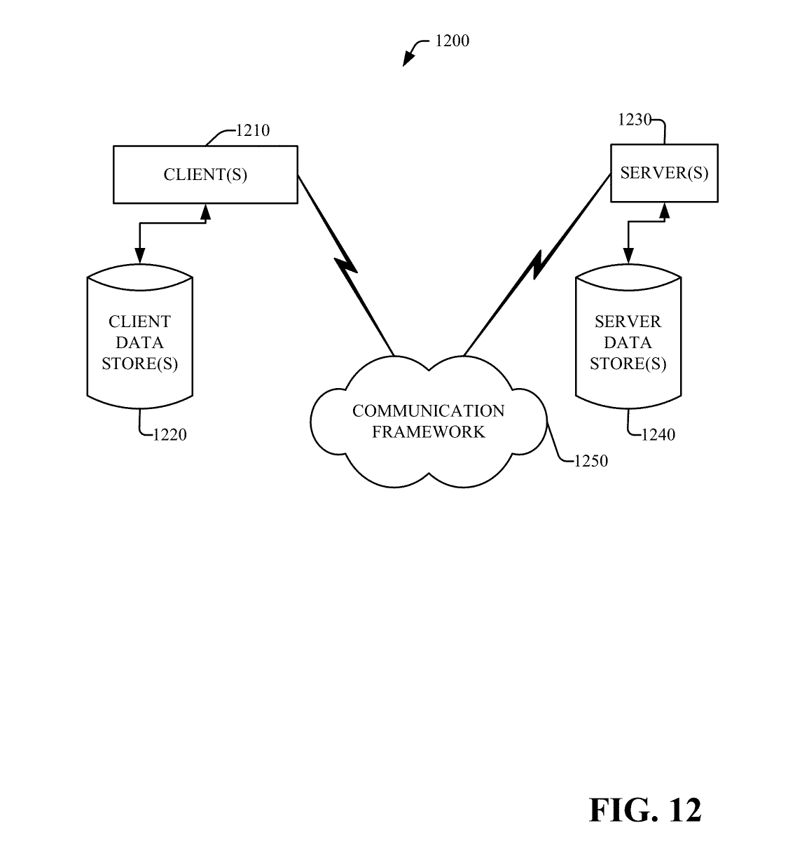

In order to provide a context for the various aspects of the disclosed subject matter, FIGS. 11 and 12 as well as the following discussion are intended to provide a brief, general description of a suitable environment in which the various aspects of the disclosed subject matter may be implemented.

With reference to FIG. 11, a suitable environment 1100 for implementing various aspects of this disclosure includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 also includes removable/non-removable, volatile/nonvolatile computer storage media. FIG. 11 illustrates, for example, a disk storage 1124. Disk storage 1124 includes, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used, such as interface 1126.

FIG. 11 also depicts software that acts as an intermediary between users and the basic computer resources described in the suitable operating environment 1100. Such software includes, for example, an operating system 1128. Operating system 1128, which can be stored on disk storage 1124, acts to control and allocate resources of the computer system 1112. System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 with which the subject matter of this disclosure can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing this disclosure, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1220 that can be employed to store information local to the client(s) 1210. Similarly, the server(s) 1230 are operatively connected to one or more server data store(s) 1240 that can be employed to store information local to the servers 1230.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components (e.g., media classification component, media database component, matching component, policy component, modification component, etc.), as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system, comprising:
a memory that stores computer executable components;
a processor that executes at least the following computer executable components stored in the memory:
a media database component that manages a set of advertisement items associated with media content; and
a matching component that:
compares media signature data associated with a media item to other media signature data associated with the set of advertisement items;
determines whether at least a portion of the media item matches at least one of the set of advertisement items based on the comparison; and
stores at least the portion of the media item in a database in response to determining that at least the portion of the media item matches an advertisement item from the set of advertisement items.

2. The system of claim 1, wherein the media database component removes an advertisement item from the set of advertisement items in response to a defined criterion.

3. The system of claim 1, wherein the media database component removes an advertisement item from the set of advertisement items after a defined period of time.

4. The system of claim 1, wherein the matching component further associates the media item with an event in response to determining that at least the portion of the media item matches the advertisement item from the set of advertisement items.

5. The system of claim 1, wherein the matching component compares the media item to the set of advertisement items in response to receiving a request for a service associated with the media item.

6. The system of claim 5, further comprising a policy component that grants the service to a user identity associated with the media item in response to determining that the media item does not match an advertisement item from the set of advertisement items.

7. The system of claim 1, wherein the matching component compares an uploaded media item that is received from a user device to the set of advertisement items based on the media signature data, and stores at least a portion of the uploaded media item in the database in response to determining that at least the portion of the uploaded media item matches the advertisement item from the set of advertisement items.

8. The system of claim 7, further comprising a policy component that grants a service associated with the uploaded media item to a user identity associated with the uploaded media item in response to determining that the uploaded media item does not match an advertisement item from the set of advertisement items.

9. The system of claim 1, wherein the matching component compares a reference media item that is selected by a user to the set of advertisement items based on the media signature data.

10. The system of claim 9, further comprising a modification component that generates a modified version of the reference media item in response to determining that at least a portion of the reference media item matches an advertisement item from the set of advertisement items.

11. The system of claim 9, further comprising a policy component that withholds from activating a service for the reference media item in response to determining that at least a portion of the reference media item matches an advertisement item from the set of advertisement items.

12. The system of claim 1, wherein the matching component determines similarity between the media fingerprint data associated with the media item and the other media fingerprint data associated with the set of advertisement items.

13. A method, comprising:
employing a processor that facilitates execution of computer executable instructions stored on a non-transitory computer readable medium to implement operations, comprising:
managing a set of advertisement items associated with media content;
determining similarity between media signature data associated with a media item and other media signature data associated with the set of advertisement items;
determining whether at least a portion of the media content item matches at least one of the set of advertisement items based on the similarity; and
storing at least the portion of the media item in a database in response to determining that at least the portion of the media item corresponds to an advertisement item from the set of advertisement items.

14. The method of claim 13, further comprising:
removing an advertisement item from the set of advertisement items after a defined period of time.

15. The method of claim 13, wherein the determining the similarity comprises determining the similarity between the media signature data associated with the media item and the other media signature data associated with the set of advertisement items in response to receiving a request for a service associated with the media item.

16. The method of claim 15, further comprising:
granting the service to a user identity associated with the media item in response to determining that the media item does not correspond to an advertisement item from the set of advertisement items.

17. The method of claim 13, further comprising:
generating a modified version of the media item in response to determining that at least the portion of the media item corresponds to an advertisement item from the set of advertisement items.

18. The method of claim 17, further comprising:
withholding from activating a service for the media item in response to determining that at least the portion of the media item corresponds to an advertisement item from the set of advertisement items.

19. The method of claim 13, wherein the determining the similarity comprises determining similarity between media fingerprint data associated with the media item and other media fingerprint data associated with the set of advertisement items.

20. A non-transitory computer readable storage medium comprising computer-executable instructions, that in response to execution, cause a computing system to perform operations, comprising:
managing a set of advertisement items associated with media content;
comparing media signature data associated with a media item to other media signature data associated with the set of advertisement items;
determining whether at least a portion of the media item matches at least one of the set of advertisement items based on the comparison; and
storing an advertisement item associated with at least a portion of the media item in a database in response to determining that at least the portion of the media item corresponds to another advertisement item included in the set of advertisement items.
